(19) United States
(12) Patent Application Publication
(10) Pub. No.: US 2006/0126994 A1
(43) Pub. Date: Jun. 15, 2006

(54) Optical module and method of manufacturing the same

(75) Inventors: Masayoshi Higuchi, Soraku-gun (JP); Kazuyuki Hayamizu, Kyotanabe-shi (JP)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: OMRON Corporation, Kyoto-shi (JP)

(21) Appl. No.: 11/302,046

(22) Filed: Dec. 13, 2005

(30) Foreign Application Priority Data
Dec. 14, 2004 (JP) 2004-361109

(51) Int. Cl. G02B 6/12

(52) U.S. Cl. 385/14; 385/49

(57) ABSTRACT

An optical module wherein an electrical signal leak from the light-emitting device or the like or a crosstalk between a light-emitting device and a light-receiving device is difficult to occur, even if the light-emitting device or the light-receiving device is arranged close to an optical waveguide or an optical fiber. An optical waveguide is mounted as laminated on the top face of a silicon substrate. The end face of the optical waveguide is cut by a dicing blade or laser beam so as to be finished to be smooth, and a cut groove is formed on the silicon substrate by this process. A slope is formed at the edge of the cut groove between the cut groove and an electrode pad, wherein the top face of the silicon substrate and the surface of the slope are covered with an insulating film. The light-emitting device is bonded on the electrode pad with a brazing filler metal.

### TECHNICAL FIELD

The present invention relates to an optical module such as an optical waveguide module or optical fiber module, and its manufacturing method.

### DESCRIPTION OF RELATED ART

Depending upon the ultimate to use an optical fiber, there are generally two types of optical communication systems using an optical fiber. One is an SS (single star) system in which a media converter is connected to an optical waveguide module at the user side for linking the base station and the user with one optical fiber. The other is a PON (Passive Optical Network) system in which a single optical fiber is branched on the way from the base station to the user by using an optical splitter, so that plural users share the optical fiber. Of the two systems, the PON system can reduce costs for an optical fiber or its laying cost, thereby being capable of providing a low-cost communication service. Therefore, the PON system is currently a popular choice.

In the PON system, it is necessary to branch a single optical fiver into plural optical fibers. Therefore, it is necessary to decrease coupling loss between an optical component and an optical waveguide in an optical waveguide module using an optical component such as a light-emitting device or light-receiving device. There is a method in which a distance between the optical waveguide and the optical component is shortened in order to decrease the coupling loss. Conventionally, the distance between the optical waveguide and the optical component is set to approximately 100 to 70 μm. However, it is effective for decreasing the coupling loss to shorten the distance between the optical waveguide and the optical component to about 20 μm.

In order to realize further reduced cost in the low-cost PON system, it is necessary to reduce the cost of the optical waveguide module itself. Conventionally, an optical waveguide made of quartz or polymer is mounted on a silicon substrate, and after that, unnecessary sections of the optical waveguide are removed by etching to expose the area on which the optical component is to be mounted and the end face of the optical waveguide on the silicon substrate. However, this method has many processing steps, and as a result, the optical waveguide module itself becomes expensive.

In view of this, a method is proposed wherein an optical waveguide is cut by dicing to remove the unnecessary sections of the optical waveguide, thereby exposing the area where an optical component is to be mounted, and the end face of the optical waveguide is smoothly exposed without being roughened. According to this method, the optical waveguide is cut by a dicing blade, so that the unnecessary sections of the optical waveguide are only separated from a silicon substrate. This method enables further cost reductions of an optical module. Notably, silicon, as mentioned above, is suitable for a material of a substrate on which an optical component is mounted. This is because silicon can efficiently radiate heat generated from the optical component due to its high thermal conductivity.

### SUMMARY

The following presents a simplified summary in order to provide a basic understanding of one or more aspects of the invention. This summary is not an extensive overview of the invention. It is not intended to identify key or critical elements, nor to delineate the scope of the claimed subject matter. Rather, the sole purpose of this summary is to present some concepts of the invention in a simplified form as a prelude to the more detailed description that is presented hereinafter.

In accordance with one aspect of the present invention, an optical module containing a non-insulating substrate containing a groove thereby forming a first region and a second region of the non-insulating substrate; at least one of an optical waveguide and an optical fiber provided over the first region; a first insulating film formed over at least a portion of the second region; a second insulating film formed within at least a portion of the groove; an electrode provided on the first insulating film; and an optical component bonded to the electrode and positioned in a vicinity of the groove.

In accordance with another aspect of the present invention, an optical module contains a non-insulating substrate containing a groove thereby forming a first region and a second region of the non-insulating substrate; at least one of an optical waveguide and an optical fiber provided over the first region; an insulating film formed over at least a portion of the second region; an insulating material filled in at least a portion of the groove; an electrode provided on the insulating film; and an optical component bonded to the electrode and positioned in a vicinity of the groove.

In accordance with still another aspect of the present invention, a manufacturing method is provided that involves forming a first insulating film on at least a second region of a non-insulating substrate, the non-insulating substrate containing a first region and the second region; forming a V-shaped groove in the non-insulating substrate between the first region and the second region; forming a second insulating film in the V-shaped groove; providing an electrode on the first insulating film in the second region; providing at least one of an optical waveguide and an optical fiber on the first region; forming a groove in the V-shaped groove, the groove in the non-insulating substrate being deeper than the V-shaped groove; and bonding an optical component to the electrode after forming the groove.

In accordance with still another aspect of the present invention, a manufacturing method is provided that involves forming a first insulating film on at least a portion of a second region and at least a portion of a middle region of a non-insulating substrate, the non-insulating substrate containing a first region, the middle region, and the second region; removing at least a portion of the first region and at least a portion of a middle region of the non-insulating substrate; forming a second insulating film on at least a portion of the removed portion of the middle region; providing an electrode on the first insulating film; providing at least one of an optical waveguide and an optical fiber on the first region; forming a groove in at least a portion of the middle region; and bonding a optical component to the electrode after forming the groove.

In accordance with still another aspect of the present invention, a manufacturing method is provided that involves forming a first insulating film on at least a second region of a non-insulating substrate, the non-insulating substrate containing a first region and the second region; providing an electrode on the first insulating film in the second region; providing at least one of an optical waveguide and an optical fiber on the first region; forming a groove between the first region and the second region; forming a second insulating film within at least a portion of the groove; and bonding an optical component to the electrode after forming the groove.

It should be noted that the constituent features of the present invention explained above can optionally be combined, if possible. To the accomplishment of the foregoing and related ends, the invention, then, contains the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following description when considered in conjunction with the drawings.

### BRIEF DESCRIPTION OF THE DRAWINGS

FIG. 1 shows a sectional view showing a part of an optical waveguide module.

FIG. 2 shows a plan view showing an optical transceiver according to a first embodiment of the present invention.

FIG. 3 shows an enlarged partial sectional view showing a neighborhood of a light-emitting device in the optical transceiver in the first embodiment.

FIG. 4A shows an enlarged plan view showing the neighborhood of the light-emitting device in the first embodiment, and FIG. 4B shows an enlarged plan view showing the neighborhood of an electrode pad, omitting the light-emitting device.

FIGS. 5A, B and C show views for explaining a manufacturing process of the optical transceiver according to the first embodiment.

FIGS. 6A, B and C show views for explaining a manufacturing process after the process shown in FIG. 5.

FIGS. 7A, B and C show views for explaining a manufacturing process after the process shown in FIG. 6.

FIG. 8 shows an enlarged partial sectional view showing an example in which the mounting position of the light-emitting device is different.

FIG. 9 shows an enlarged partial sectional view showing a modified example of the first embodiment.

FIG. 10 shows an enlarged partial sectional view showing a part of an optical transceiver according to a second embodiment of the present invention.

FIG. 11 shows a plan view showing an optical transmitter according to a third embodiment of the present invention.

FIG. 12 shows an enlarged partial sectional view showing a neighborhood of a light-emitting device in the optical transmitter in the third embodiment.

FIG. 13A shows an enlarged plan view showing the neighborhood of the light-emitting device in the third embodiment, and FIG. 13B shows an enlarged plan view showing the neighborhood of an electrode pad, omitting the light-emitting device.

FIGS. 14A, B and C show views for explaining a manufacturing process of the optical transmitter according to the third embodiment.

FIGS. 15A, B and C show views for explaining a manufacturing process after the process shown in FIG. 14.

FIGS. 16A, B and C show views for explaining a manufacturing process after the process shown in FIG. 15.

FIG. 17 shows an enlarged partial sectional view showing a modified example of the third embodiment.

FIG. 18 shows an enlarged partial sectional view showing an optical waveguide module according to a fourth embodiment of the present invention.

FIG. 19 shows an enlarged partial sectional view showing a modified example of the fourth embodiment of the present invention.

FIG. 20 shows an enlarged partial sectional view showing an optical waveguide module according to a fifth embodiment of the present invention.

FIGS. 21A, B and C show schematic sectional views for explaining a manufacturing process of an optical fiber module according to a sixth embodiment of the present invention.

### DETAILED DESCRIPTION

Embodiments of the present invention are explained in detail hereinafter with reference to drawings. It should be noted that the present invention is not limited to the embodiments explained below. Further, the invention can appropriately be modified in design according to a particular use.

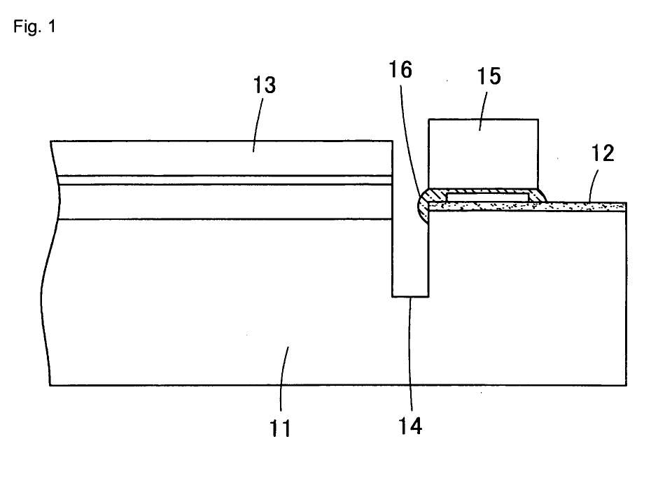

A processing method with the use of dicing is explained hereinafter with reference to a sectional view shown in FIG. 1. As shown in FIG. 1, an optical waveguide 13 is mounted on a surface of a silicon substrate 11 having an insulating film 12 formed thereon. Thereafter, dicing is performed from the optical waveguide 13 to the silicon substrate 11, thereby forming a cut groove 14. Then, an optical component 15 is arranged on the region adjacent to the cut groove 14 of the silicon substrate 11 so as to make the optical component 15 close as much as possible to the end face of the optical waveguide 13. Then, the optical component 15 is bonded to an electrode pad on the insulating film 12 by using a brazing filler metal 16 such as solder or tin.

However, according to this method by using dicing, the insulating film 12 on the surface of the silicon substrate 11 is also cut upon cutting the optical waveguide 13, so that the silicon substrate 11 is exposed on the cut groove 14. When the optical component 15 is bonded to the electrode pad with the brazing filler metal 16 with this state, there is a possibility that the melted brazing filler metal 16 undesirably sticks out or is undesirably dripped into the cut groove 14. When the brazing filler metal 16 sticks out or is dripped into the cut groove 14 so that it is in contact with the silicon substrate 11, an electrical signal leaks between the optical component 15 and the silicon substrate 11. As a result, a problem arises in the case of an optical transceiver that electrical crosstalk occurs between the light-emitting device and light-receiving device that are mounted on the surface of the silicon substrate 11. Further, in the case of an optical transmitter or optical receiver, crosstalk might occur between the light-emitting device and light-receiving device through a circuit board on which an optical waveguide is mounted or contact might occur between light-receiving devices.

Accordingly, it is typically necessary, in the method for cutting the optical waveguide by dicing, to mount an optical component so that it is greatly separated from the upper side of the cut groove. As a result of the large separation, there are limitations as to decreasing coupling efficiency between the optical component and optical waveguide.

### EMBODIMENT 1

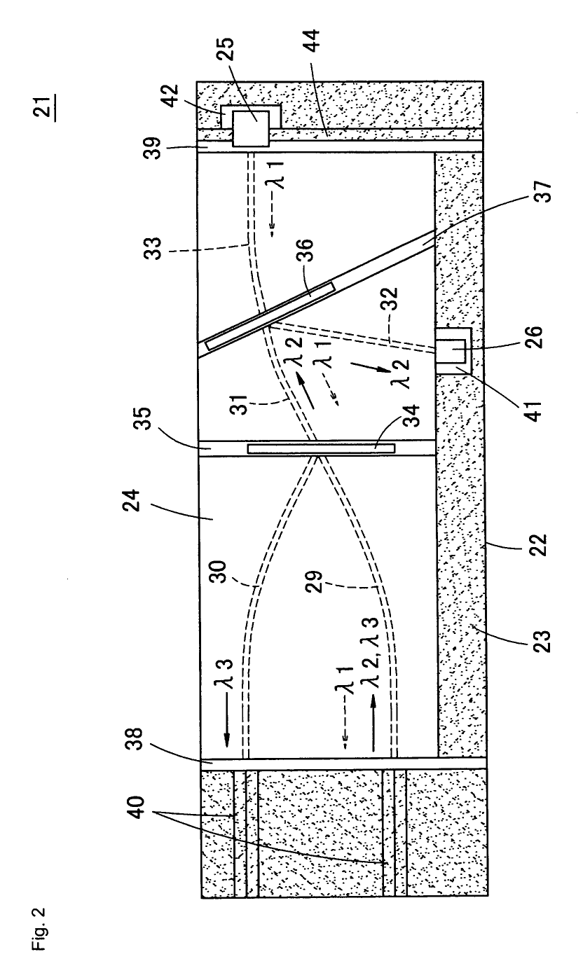

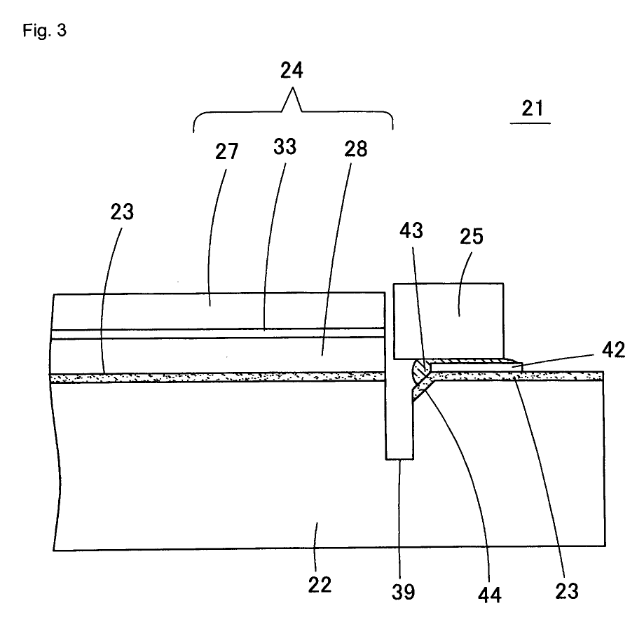

FIG. 2 shows a plan view showing an optical transceiver (optical waveguide module) according to an embodiment of the present invention. FIG. 3 shows an enlarged partial sectional view showing the neighborhood of a light-emitting device of the optical transceiver. This optical transceiver 21 has an optical waveguide 24, light-emitting device 25 and light-receiving device 26 mounted on the surface of a silicon substrate 22 on which an insulating film 23 made of SiO₂, SiN or the like is formed. Examples of the light-emitting device 25 include an LD (laser diode) or the like. Examples of the light-receiving device 26 include a photodiode or the like. Further, a pair of V-shaped optical fiber holding sections 40 is provided on the surface of the silicon substrate 22.

The optical waveguide 24 is formed by laminating an upper clad 27 and a lower clad 28 made of a transparent resin material. Cores 29 to 33 having a refractive index greater than those of the upper and lower clads 27 and 28 are embedded into a core provided at the upper clad 27 or the lower clad 28. Further, a filter insertion groove 35 and a filter insertion groove 37 are formed on the optical waveguide 24 so as to cross the optical waveguide 24 in the widthwise direction. The filter insertion groove 35 is a groove into which a filter device 34 is inserted, while the filter insertion groove 37 is a groove into which a filter device 36 is inserted. Cores 29 and 30 are provided at the region, among the regions of the optical waveguide 24 separated by the filter insertion grooves 35 and 37, that is opposite to the filter insertion groove 37 with the filter insertion groove 35 as a border. Cores 31 and 32 are provided at the middle region between the filter insertion groove 35 and the filter insertion groove 37. A core 33 is arranged at the region, among the regions of the optical waveguide 24, that is opposite to the filter insertion groove 35 with the filter insertion groove 37 as a border.

The optical waveguide 24 has a pair of end faces opposing to each other in the longitudinal direction and a pair of side faces opposing each other in the widthwise direction. An optical fiber holding section 40 is provided on the surface of the silicon substrate 22 at the position opposing one end face of the optical waveguide 24. Accordingly, the end face and end section of the optical waveguide 24 and core at this side are referred to as an optical-fiber-connection-side end face and optical-fiber-connection-side end section. Further, a light-emitting device 25 is mounted on the surface of the silicon substrate 22 at the position opposing the other end face of the optical waveguide 24. Therefore, the end face and end section of the optical waveguide 24 and each core at this side are referred to as a light-emitting-device-side end face and light-emitting-device-side end section. Further, a light-receiving device 26 is mounted on the surface of the silicon substrate 22 at the position opposing one side face of the optical waveguide 24. Therefore, the side face and side end section of the optical waveguide 24 and each core at this side are referred to as a light-receiving-device-side side face and light-receiving-device-side side end section. (The above definitions are applied to the second embodiment and the following embodiments).

The optical-fiber-connection-side end sections of the cores 29 and 30 are linearly formed and arranged in parallel to each other in the vicinity of the optical-fiber-connection-side end section of the optical waveguide 24. In this context, vicinity means capable of optical coupling. Moreover, the optical-fiber-connection-side end faces of the cores 29 and 30 are exposed at the optical-fiber-connection-side end face of the optical waveguide 24. The end faces of the cores 29 and 30 opposite to the optical-fiber-connection-side end faces are exposed in the filter insertion groove 35 so as to be opposite to the filter device 34 inserted in the filter insertion groove 35. Further, the lengthwise direction of the cores 29 and 30 at the end sections opposite to the optical-fiber-connection-side end sections form angles, equal to each other in a different direction, with the normal direction of the face of the filter device 34, that is inserted into the filter insertion groove 35, opposite to the cores 29 and 30 viewed from a plane.

At the vicinity of the filter insertion groove 35, the end face of the core 31 is exposed in the filter insertion groove 35 and opposed to the filter device 34. Further, the end section of the core 31 opposite to the filter insertion groove 35 has an angle determined so as to smoothly communicate with the end section of the core 29 opposite to the optical-fiber-connection-side end section. At the vicinity of the filter insertion groove 37, the end face of the core 31 and the end face of the core 32 are exposed in the filter insertion groove 37 and opposed to the filter device 36 inserted into the filter insertion groove 37. Further, the lengthwise direction of the cores 31 and 32 at the end sections opposite to the filter insertion groove 37 form angles, equal to each other in a different direction, with the normal direction of the face of the filter device 36, that is inserted into the filter insertion groove 37, opposite to the cores 31 and 32 viewed from a plane. The light-receiving-device-side side end section of the core 32 reaches the light-receiving-device-side side end section of the optical waveguide 24, while the light-receiving-device-side side end face of the core 32 is exposed at the light-receiving-device-side side end face of the optical waveguide 24.

At the vicinity of the filter insertion groove 37, the end face of the core 33 opposite to the light-emitting-device-side end face is exposed in the filter insertion groove 37 and opposed to the filter device 36 inserted into the filter insertion groove 37. Further, the end section of the core 33 opposite to the filter insertion groove 37 has an angle determined so as to smoothly communicate via the filter insertion groove 37 with the end section of the core 31 opposite to the filter insertion groove 37. The light-emitting-device-side end section of the core 33 is linearly formed in the vicinity of the light-emitting-device-side end section of the optical waveguide 24. The light-emitting-device-side end face of the core 33 is exposed at the light-emitting-device-side end face of the optical waveguide 24.

The filter device 34 has characteristics of a shortwave transmission for transmitting light having wavelength of λ1 and wavelength of λ2 and reflecting light having wavelength of λ3. The filter device 36 has characteristics for transmitting light having wavelength of λ1 and reflecting light having wavelength of λ2. Here, the equation of λ1<λ2<λ3 is established in which λ1=1.31 μm, λ2=1.49 μm and λ3=1.55 μm, for example.

An insulating film 23 is formed on the surface of the silicon substrate 22. As shown in FIG. 3, the optical waveguide 24 is mounted on the silicon substrate 22 via the insulating film 23. However, the optical waveguide 24 may directly be mounted on the silicon substrate 22 without forming the insulating film 23 on the silicon substrate 22 at the region where the optical waveguide is to be mounted. Further, in this embodiment, the insulating film 23 covers the whole region on the surface of the silicon substrate 22 exposed from the optical waveguide 24. However, the insulating film 23 may be formed only on the region on the surface of the silicon substrate 22 where the optical component is to be mounted. The region where the optical component is to be mounted means the region where electrode pads 41 and 42 are formed and its surrounding region (the region sufficiently wide compared to the region where a brazing filler metal might stick out).

The end section of the optical waveguide 24 mounted on the surface of the silicon substrate 22 is cut by dicing or the like as described later, so that the end face is finished to be smooth. At this time, cut grooves 38 and 39 located at the position in contact with the end face of the optical waveguide 24 reach up to the silicon substrate 22 in order to surely cut the end face. Referring to FIG. 3, the cut groove 39 creates two regions on either side thereof, a first region with the optical waveguide 24 thereover, and a second region with the light-emitting device 25 thereover.

Optical fiber holding sections 40 each having a form of a V-shaped groove are concavely provided on the surface of the silicon substrate 22 at the position opposing the optical-fiber-connection-side end sections of the cores 29 and 33. An optical fiber (not shown) is provided at each optical fiber holding section 40 and optically coupled to the cores 29 and 30. Further, an electrode pad 41 is provided on the surface of the silicon substrate 22 at the position opposing the light-receiving-device-side side end face of the core 32. The light-receiving device 26 bonded on the electrode pad 41 is optically coupled to the core 32. An electrode pad 42 is provided on the surface of the silicon substrate 22 at the position opposing the light-emitting-device-side end face of the core 33. The light-emitting device 25 bonded thereon with a brazing filler metal 43 is optically coupled to the core 33. The distance between the light-emitting device 25 and the core 33 and the distance between the light-receiving device 26 and the core 32 are preferably set to be short as much as possible, desirably being set to about 20 μm, for example.

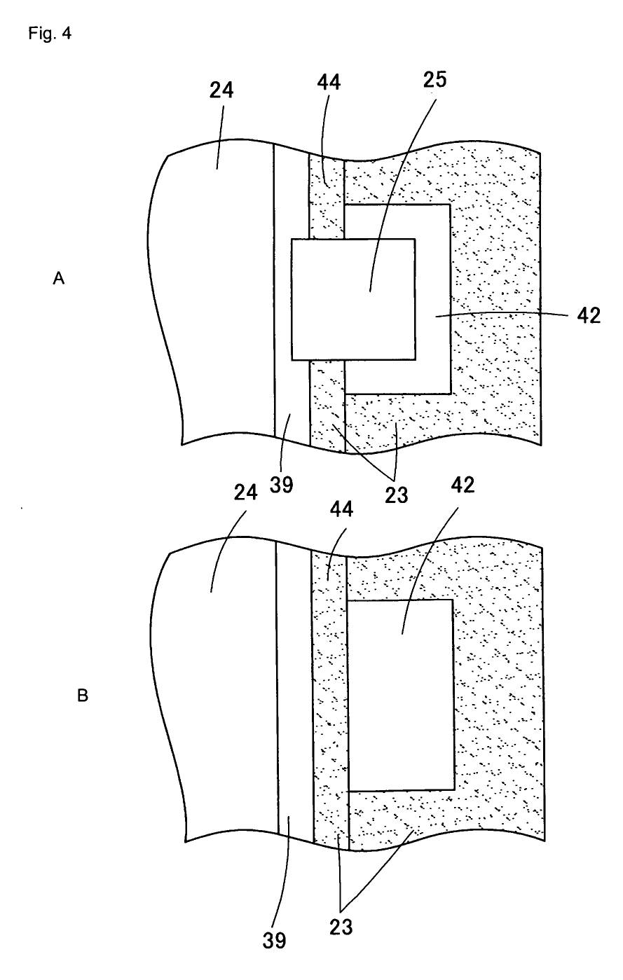

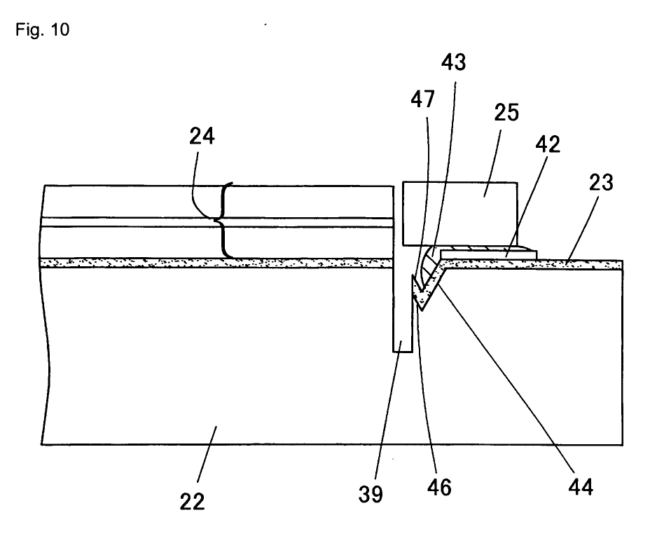

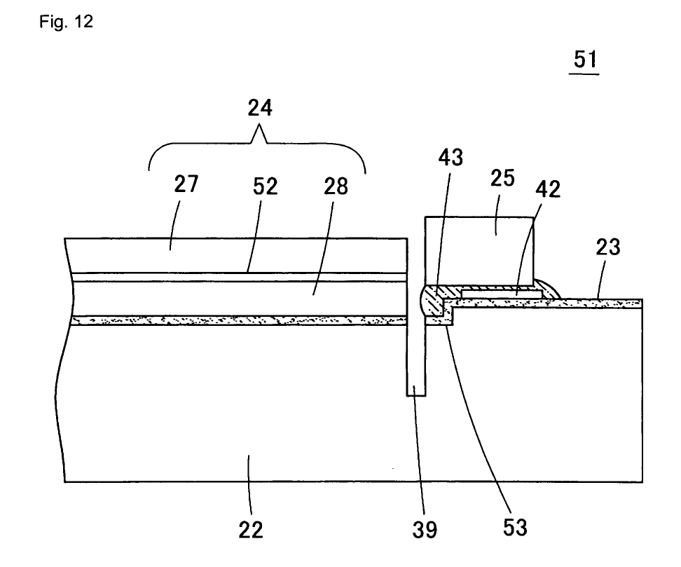

As shown in FIG. 3, a slope 44 inclined diagonally downward from the substrate surface toward the cut groove 39 is provided at the middle of the mounting region of the light-emitting device 25 and the cut groove 39 at the side where the electrode pad 42 is provided. The insulating film 23 is also formed on the whole face of the slope 44 so as to continuously communicate with the insulating film 23 on the surface of the silicon substrate 22. A groove is formed by the cut groove 39 and the slope 44. FIG. 4A shows an enlarged plan view showing the neighborhood of the light-emitting device 25, while FIG. 4B shows an enlarged plan view showing the neighborhood of the electrode pad 42 omitting the light-emitting device 25. As understood from FIG. 2 and FIGS. 4A and B, the slope 44 is formed over the width of the silicon substrate 22 in this embodiment. However, the slope 44 may be partially formed at the edge of the cut groove 39 with a width greater than the width of the mounting region of the light-emitting device 25 (for example, see embodiment 2). Further, the insulating film 23 is formed only on the slope 44 within the groove 39. The groove is an opening in the substrate below the planar surface thereof and includes a trench-like region and optionally one or more of a slope (See FIGS. 3, 8, and 9), slope and reverse slope (see FIG. 10), and one or more steps (see FIG. 12)

Light of each wavelength is controlled as described below in this optical transceiver 21. When light having wavelength of λ2 and λ3 is incident from one optical fiber to the core 29, this light is propagated through the core 29. Then, among light emitted from the end face of the core 29, the light having wavelength of λ3 is reflected by the filter device 34 and propagated through the core 30 to be optically coupled to the other optical fiber. This state is shown by a solid arrow in FIG. 2. The light of wavelength λ2 passes through the filter device 34. The light of wavelength λ2 passing through the filter device 34 is incident into the core 31, propagated through the same and emitted from the end face of the core 31. Then, the light of wavelength λ2 is reflected by the filter device 36, propagated through the core 32 and emitted from the end face of the core 32. The light of wavelength λ2 emitted from the end face of the core 32 is received by the light-receiving device 26.

The light of wavelength λ1 emitted from the light-emitting device 25 is propagated through the core 33 as shown by an arrow of broken line in FIG. 2. The light of wavelength λ1 emitted from the core 33 passes through the filter device 36 to be incident into the core 31 and is propagated through the core 31. The light of wavelength λ1 emitted from the end face of the core 31 passes through the filter device 34 to be incident into the core 29, and is propagated through the core 29. The light emitted from the end face of the core 29 is optically coupled to one optical fiber.

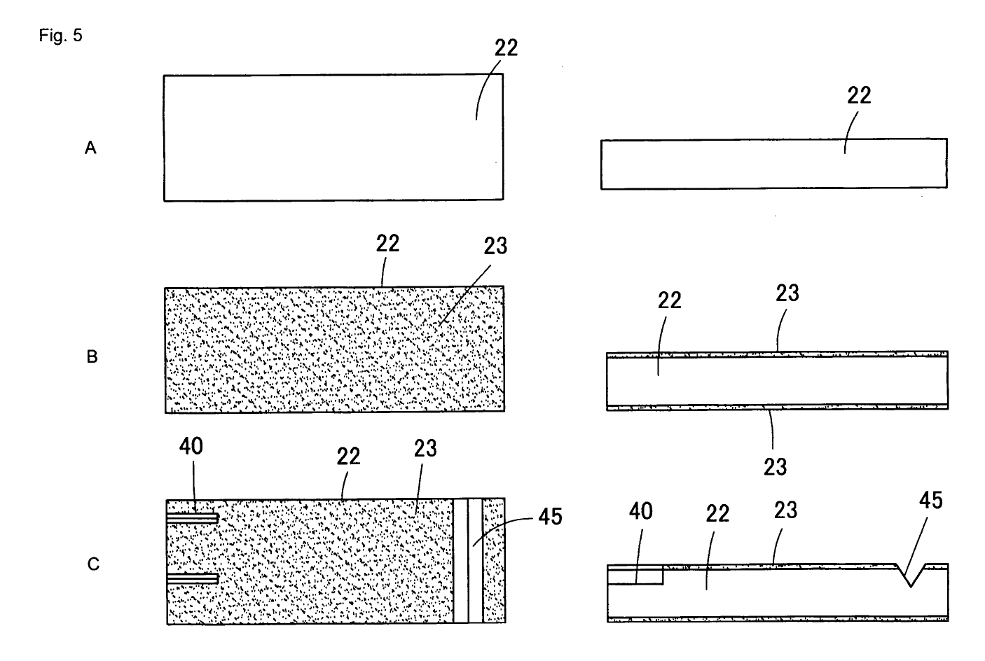

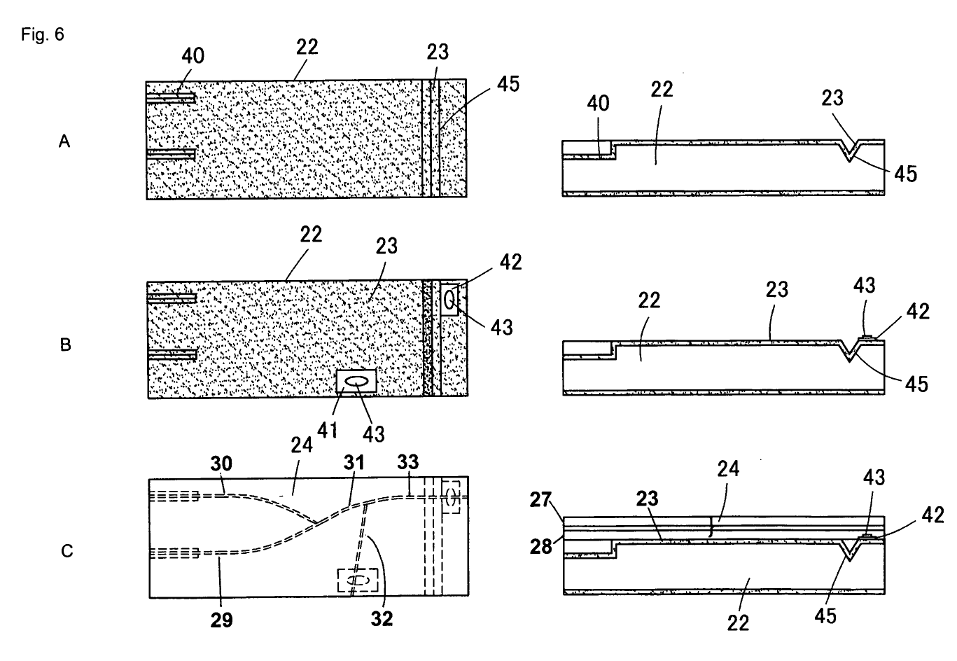

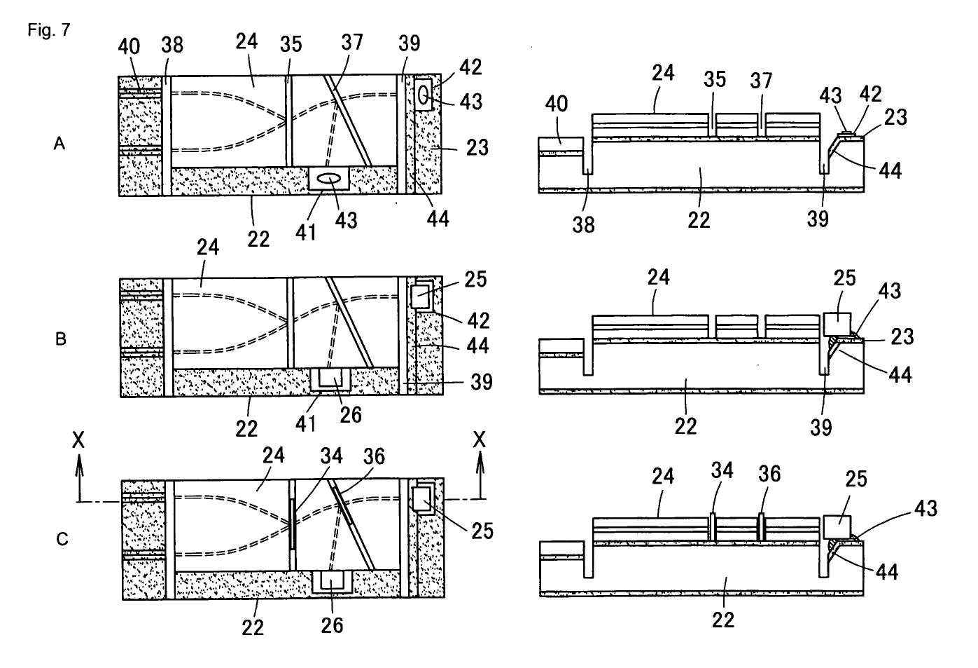

Subsequently, an example of a manufacturing method of an optical transceiver 21 according to an embodiment of the present invention is explained. FIGS. 5A, B and C, FIGS. 6A, B and C and FIGS. 7A, B and C show views for explaining a manufacturing process of the optical transceiver 21. In any one of these views, the views on the left side represent a plane and the views on the right side represent a cross-section at the part corresponding to X-X sectional view in FIG. 7C. Upon manufacturing the optical transceiver 21, the silicon substrate 22 (silicon wafer) shown in FIG. 5A is prepared. As shown in FIG. 5B, front and back faces of the silicon substrate 22 are thermally oxidized to form the insulating film 23 (thermal oxide film) made of SiO2. Further, the insulating film 23 on the surface at the region where the cut groove 39, slope 44 and optical fiber holding section 40 are to be formed is opened. The silicon substrate 22 is anisotropically etched through the opening, thereby concavely providing the optical fiber holding section 40 having a form of V-shaped groove and the V-shaped groove 45 as shown in FIG. 5C. Moreover, as shown in FIG. 6A, the optical fiber holding section 40 and the V-shaped groove 45 are thermally oxidized to form the insulating film 23 on all over the front and back faces of the silicon substrate 22. Note that the insulating film 23 on the back face of the silicon substrate 22 may be removed.

Then, as shown in FIG. 6B, the electrode pads 41 and 42 are mounted at the predetermined positions on the upper face of the silicon substrate 22 via the insulating film 23. The brazing filler metal 43 such as AuSn or the like is applied on the electrode pads 41 and 42. With this orientation, the electrode pads 41 and 42 are insulated by the insulating film 23. Further, the electrode pads 41 and 42 and the silicon substrate 22 are also insulated by the insulating film 23.

Subsequently, as shown in FIG. 6C, the optical waveguide 24 having cores 29 to 33 embedded between the upper and lower clads 27 and 28 is precisely positioned and mounted on all over the upper surface of the silicon substrate 22. The optical waveguide 24 fabricated beforehand with another process may be overlapped on the upper surface of the silicon substrate 22 and fixedly bonded by an adhesive. Further, using the clad resin as an adhesive upon forming the lower clad 28 can simplify the process. Alternatively, the lower clad 28, cores 29 to 33 and upper clad 27 may be successively formed on the silicon substrate 22 with the use of a semiconductor fabricating technique. In this process, the insulating film 23 is removed from the region where the optical waveguide is to be finally formed, so that the optical waveguide 24 may directly be bonded to the silicon substrate 22. However, the method for bonding the optical waveguide 24 via the insulating film 23 provides increased bonding strength of the optical waveguide 24. In this case, the usable insulating film 23 includes a thermal oxide film, deposition film by a CVD, or a film formed by a sputtering.

Then, as shown in FIG. 7A, the optical waveguide 24 and the silicon substrate 22 are cut by a dicing blade or laser beam at the half side of the V-shaped groove 45 apart from the light-emitting device 25, thereby forming the cut groove 39. Simultaneously, they are cut by the dicing blade or laser beam at the position passing the end section of the optical fiber holding section 40, thereby forming the cut groove 38. Moreover, the optical waveguide 24 is cut by the dicing blade or laser beam at the position passing the edge of the electrode pad 41 in the direction orthogonal to the cut grooves 38 and 39. With this process, the end face of the optical waveguide 24 is formed and the groove composed of the cut groove 39 and the V-shaped groove 45 is formed at the side of the light-emitting device 25.

The unnecessary sections of the optical waveguide 24 are separated, leaving the section encircled by the cut grooves 38 and 39 and the cutting line passing the edge of the electrode pad 41. Moreover, the filter insertion groove 35 and the filter insertion groove 37 are cut at the predetermined positions by the dicing blade or laser beam. These are formed so as to be unsusceptible to the optical coupling loss by smoothing the end face and side face of the optical waveguide 24.

In order to separate the unnecessary sections of the optical waveguide 24 from the silicon substrate 22, the adhesive may be removed by etching. Alternatively, the optical waveguide 24 is bonded to the silicon substrate 22 by using an ultraviolet curing type adhesive. In this case, the adhesive is not irradiated by ultraviolet ray at the unnecessary sections, so that the adhesive is not hardened at the unnecessary sections. Thus, the unnecessary sections of the optical waveguide 24 can easily be removed by merely using a cleaning process.

The light-receiving device 26 is bonded to the electrode pad 41 that is exposed from the optical waveguide 24 as described above. Simultaneously, the light-emitting device 25 is bonded to the electrode pad 42 and facedown-mounted. Then, the light-receiving device 26 and the light-emitting device 25 are pressurized to reflow the brazing filler metal 43. As shown in FIG. 7B, the light-receiving device 26 is bonded to the electrode pad 41 and the light-emitting device 25 is bonded to the electrode pad 42 by the reflown brazing filler metal 43.

At this time, the slope 44 is formed at the edge of the cut groove 39 by the cutting of the V-shaped groove 45 at the side of the light-emitting device 25. Since the surface of the slope 44 is covered by the insulating film 23, the brazing filler metal 43 hardly, if at all, sticks out or hardly, if at all, drips into the cut groove 39 even if the light-emitting device 25 is arranged close to the end face of the optical waveguide 24 in order to enhance the optical coupling efficiency between the light-emitting device 25 and the core 33. In particular, even if the light-emitting device 25 is arranged so as to protrude toward the upper side of the cut groove 39 as shown in FIG. 3, the brazing filler metal 43 is held or retained at the space between the bottom face of the light-emitting device 25 and the slope 44 covered with the insulating film 23 due to surface tension forces. As a result, the structure mitigates and/or eliminates the brazing filler metal 43 from undesirably dripping into the cut groove 39. Accordingly, electrical crosstalk that can be generated between the light-receiving device 26 and the light-emitting device 25 caused by contact of the dripped brazing filler metal 43 to the silicon substrate 22 in the groove 39, is mitigated and/or prevented.

When the light-emitting device 25 or the light-receiving device 26 is mounted, the light-emitting device 25 or the like is positioned with a positioning mark formed on the silicon substrate 22 (silicon wafer) as a reference. The positioning mark used for mounting the light-emitting device 25 or the like is desirably formed on the silicon substrate 22 with a mask same as that used for forming a positioning mark for bonding the optical waveguide 24. Using the same mask makes it possible to decrease the positional deviation between the optical waveguide 24 and the light-emitting device 25 or the like. Further, using the same mask upon forming the optical fiber holding section 40 enhances the positional precision between the optical waveguide 24 and the optical fiber. Moreover, as the method for mounting the light-emitting device 25 or the like, the outer pattern of the optical waveguide 24 may be actually recognized and the positioning may be performed on the basis of the end face and side face formed on the silicon substrate 22 by the cutting.

Finally, as shown in FIG. 7C, the filter device 34 is inserted into the filter insertion groove 35 and the filter device 36 is inserted into the filter insertion groove 37. Thus, the optical transceiver 21 is completed.

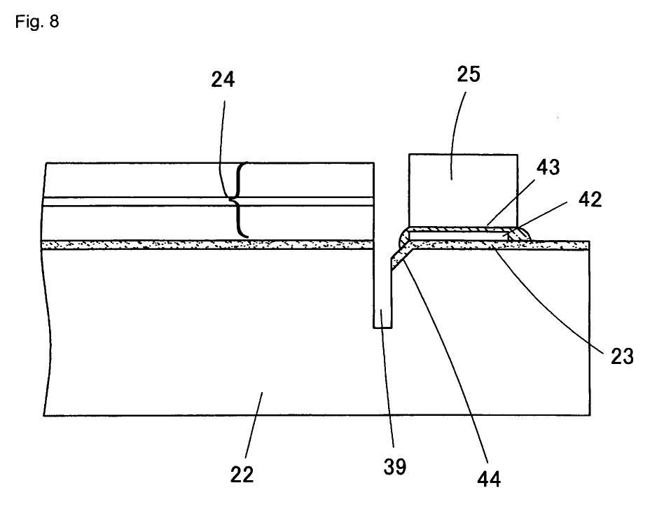

In the aforesaid embodiment, the light-emitting device 25 is bonded on the electrode pad 42 so as to protrude toward the upper side of the cut groove 39. However, the manner in which the light-emitting device 25 is mounted is not limited thereto. The light-emitting device 25 can be arranged so as to be recessed from the cut groove 39 as shown in FIG. 8, so long as a required distance is ensured between the optical waveguide 24 and the light-emitting device 25. Alternatively, the light-emitting device 25 may be arranged so as be recessed from the slope 44 (the same is true for any one of the following embodiments and modified examples).

In the aforesaid embodiment 1, only the optical waveguide 24 is cut upon cutting the optical waveguide 24 at the side of the light-receiving device 26. However, it is actually difficult to cut only the optical waveguide 24 without damaging the insulating film 23. Accordingly, it is desirable to form the slope covered with the insulating film 23 at the portion that comes in contact with the inner edge of the electrode pad 41, similar to the cut grooves 38 and 39.

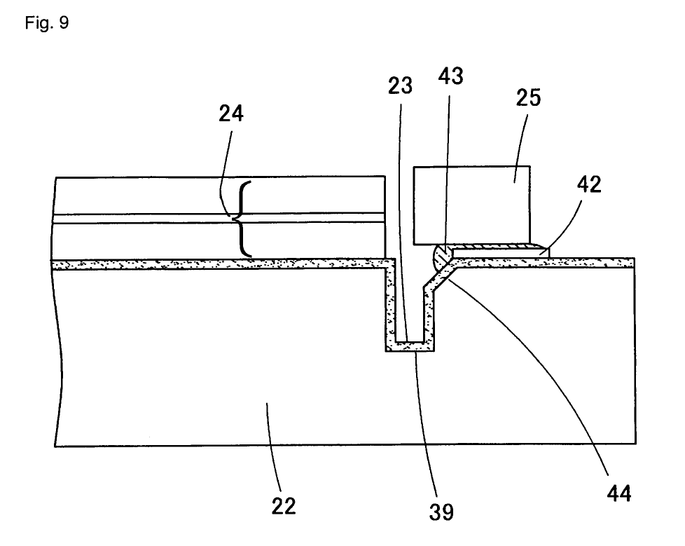

FIG. 9 shows an enlarged partial sectional view showing a modified example of the embodiment of the present invention. In this modified example, the insulating film 23 is formed over the entire inside of the cut groove 39, and the entire silicon substrate 22 is covered with the insulating film 23. In order to cover the entire inside of the cut groove 39 with the insulating film 23, the insulating film 23 is formed at the inside of the cut groove 39 by a thermal oxidation after the cut groove 39 is cut by the dicing blade or laser beam. According to this modified example, the entire cut groove 39 is covered with the insulating film 23, whereby the possibility of electrical crosstalk or electrical signal leakage is further decreased and/or prevented.

Although the optical waveguide 24 is made of resin in this embodiment, it may be made of any other suitable materials such as quartz. The same is true for the following embodiments.

### EMBODIMENT 2

FIG. 10 shows an enlarged partial sectional view showing a part of the optical transceiver according to an embodiment of the present invention. In this embodiment, a reverse slope 46 inclined diagonally upward toward the cut groove 39, contrary to the slope 44, is formed at the bottom tip of the slope 44. The surface of the reverse slope 46 is also covered with the insulating film 23. With this structure, a groove-shaped puddle section 47 of the brazing filler metal 43 is formed between the slope 44 and the reverse slope 46, whereby the dripped brazing filler metal 43 is retained at the puddle section 47. Accordingly, dripping of the brazing filler metal 43 into the cut groove 39 where the silicon substrate 22 is exposed is minimized and/or prevented.

The optical transceiver according to the second embodiment is fabricated by the method similar to the manufacturing method of the optical transceiver according to the first embodiment. However, the optical transceiver of the second embodiment can easily be fabricated by only shifting the position of cutting the cut groove 39 by the dicing blade or laser beam to the side opposite to the light-emitting device 25 more than the case of the embodiment 1.

### EMBODIMENT 3

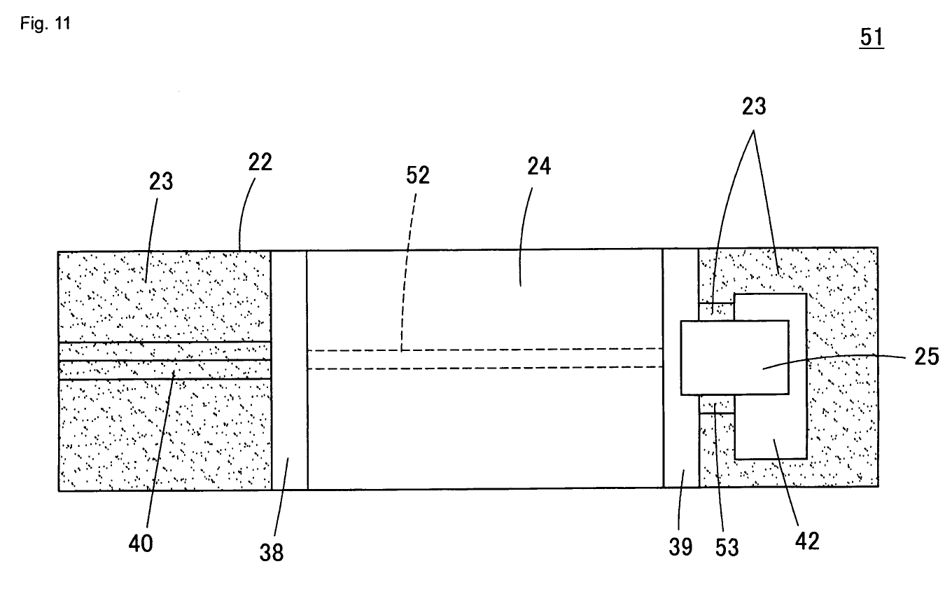

FIG. 11 shows a plan view showing an optical transmitter (optical waveguide module) according to an embodiment of the present invention. FIG. 12 shows an enlarged partial sectional view of the neighborhood of the light-emitting device. This optical transmitter 51 has an optical waveguide 24 mounted on a silicon substrate 22. Further, a light-emitting device 25 is arranged at one end section of the silicon substrate 22 in the longitudinal direction so as to oppose one end face of the optical waveguide 24, and an optical fiber holding section 40 is formed at the other end section of the silicon substrate 22 in the longitudinal direction so as to be adjacent to the end section of the optical waveguide 24 opposite to the side of the light-emitting device 25.

The optical waveguide 24 has a linear core 52 formed between an upper clad 27 and a lower clad 28 made of a transparent resin material. As shown in FIG. 12, the optical waveguide 24 is mounted on the silicon substrate 22 via the insulating film 23. However, the optical waveguide 24 may directly be mounted on the surface of the silicon substrate 22 without providing the insulating film 23 on the surface of the silicon substrate 22 at the region where the optical waveguide is to be mounted.

The end section of the optical waveguide 24 mounted on the surface of the silicon substrate 22 is cut by dicing or the like as described later, so that the end face is finished to be smooth. At this time, cut grooves 38 and 39 located at the position in contact with the end face of the optical waveguide 24 reach up to the silicon substrate 22 in order to surely cut the end section.

The optical fiber holding section 40 having a form of a V-shaped groove is concavely provided on the surface of the silicon substrate 22 at the position adjacent to the optical-fiber-connection-side end section of the core 52. An optical fiber (not shown) is provided at the optical fiber holding section 40 and optically coupled to the core 52. Further, an electrode pad 42 is provided on the surface of the silicon substrate 22 at the position adjacent to the light-emitting-device-side end section of the core 52. The light-emitting device 25 bonded on the electrode pad 42 by a brazing filler metal 43 opposes the end face of the optical waveguide 24 and is optically coupled to the core 52.

As shown in FIG. 12, a one-step lowered step portion 53 is provided between the electrode pad 42 and the cut groove 39 at the edge of the cut groove 39 to which the light-emitting device 25 is adjacent. The insulating film 23 is also formed on the whole face of the step portion 53 so as to continuously communicate with the insulating film 23 on the surface of the silicon substrate 22. A groove is formed by the cut groove 39 and the step portion 53. The silicon substrate 22 contains a first region over which optical waveguide 24 is formed, a second region over which light-emitting device 25 is formed, and a middle region containing cut groove 39.

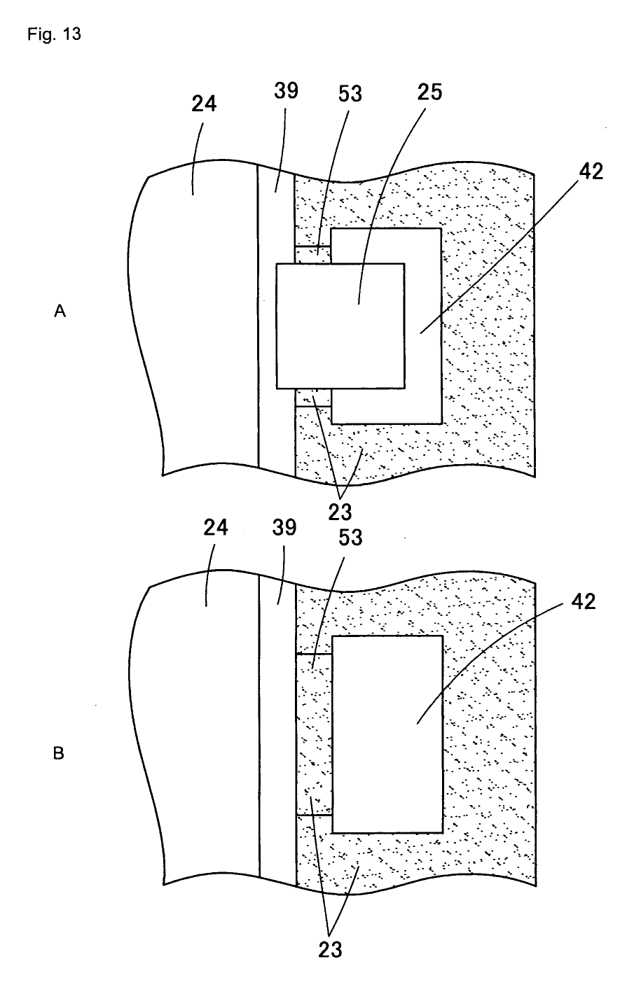

FIG. 13A shows an enlarged plan view showing the neighborhood of the light-emitting device 25, while FIG. 13B shows an enlarged plan view showing the neighborhood of the electrode pad 42 omitting the light-emitting device 25. As understood from FIGS. 13A and B, the step portion 53 is formed over the width greater than the width of the mounting region of the light-emitting device 25 only in the vicinity of the electrode pad 42 in this embodiment. alternatively, the step portion 53 may be formed over the entire width (or substantially the entire width) of the silicon substrate 22 (for example, see embodiment 1)

In this optical transmitter 51, light emitted from the core 52 is propagated through the core 52 and coupled to the optical fiber held by the optical fiber holding section 40.

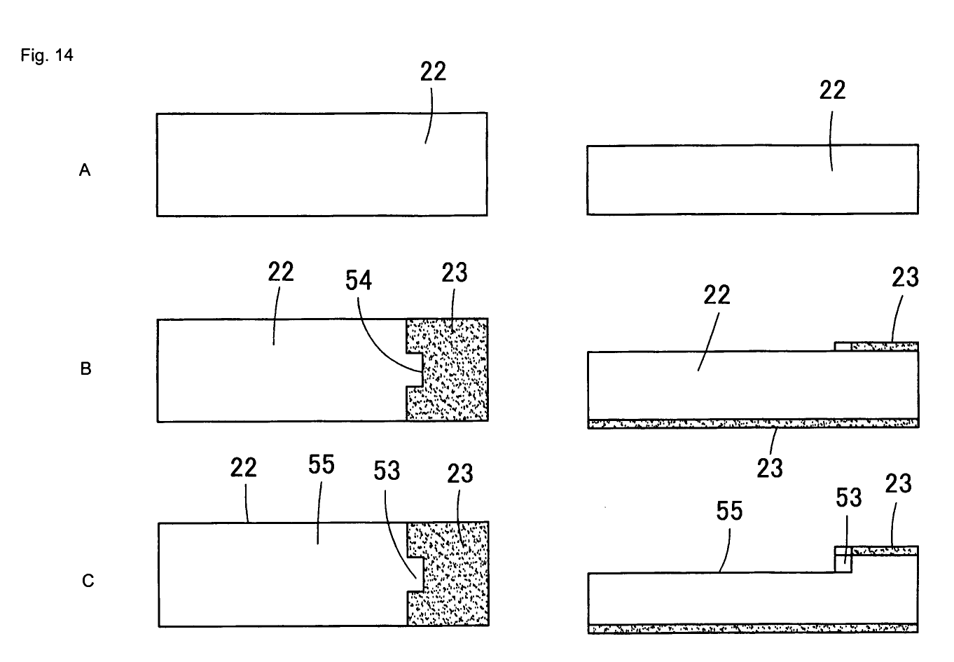

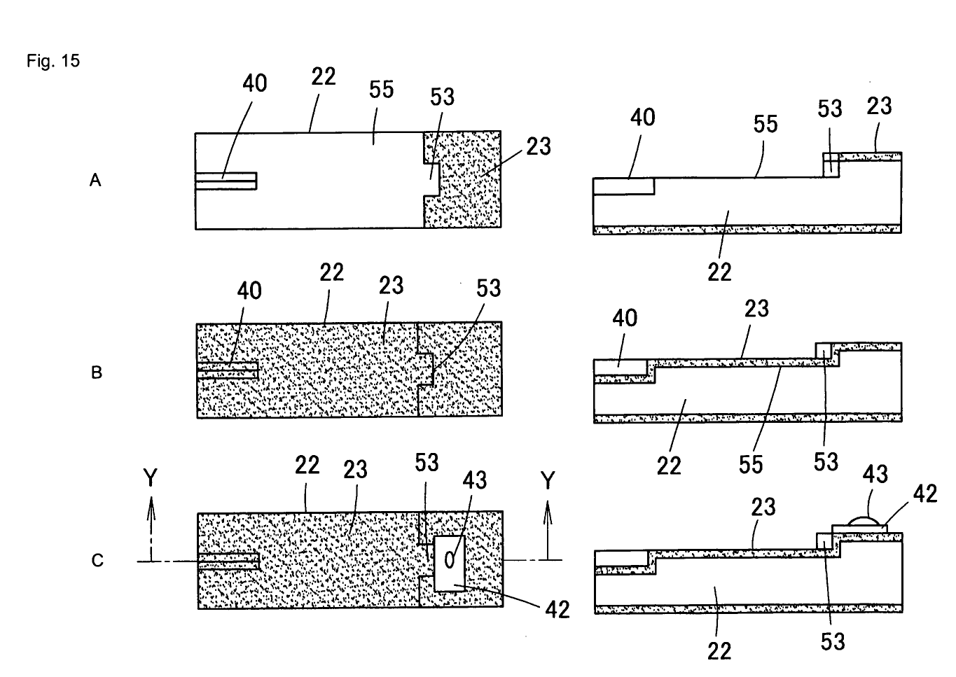

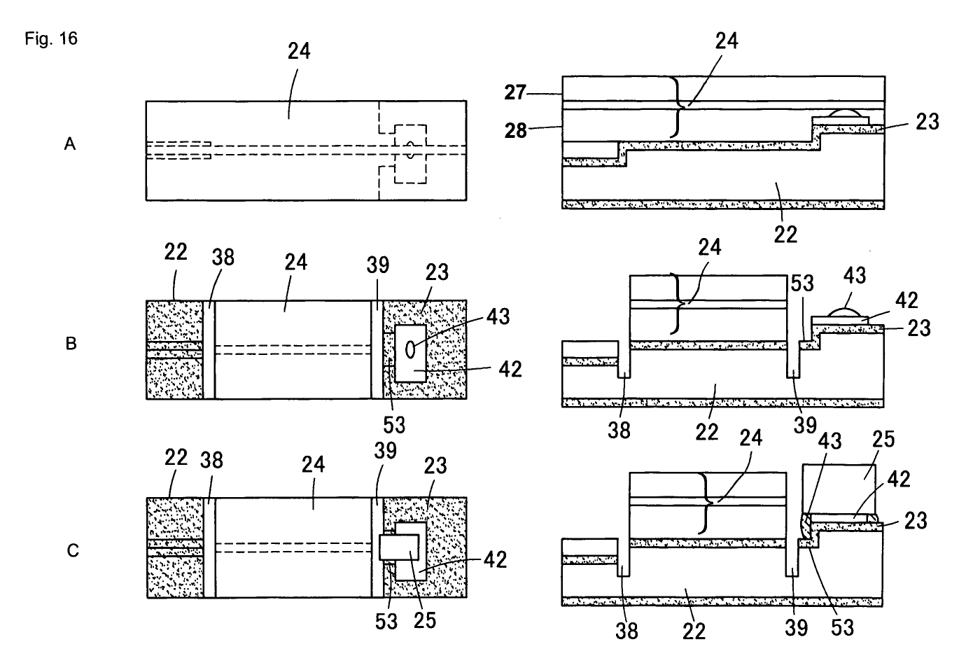

Subsequently, an example of a manufacturing method of the optical transmitter 51 according to an embodiment of the present invention is explained. FIGS. 14A, B and C, FIGS. 15A, B and C and FIGS. 16A, B and C show views for explaining a manufacturing process of the optical transmitter 51. In any one of these views, the views on the left side represent a plane and the views on the right side represent a cross-section at the part corresponding to Y-Y sectional view in FIG. 15C. Upon manufacturing the optical transmitter 51, the silicon substrate 22 (silicon wafer) shown in FIG. 14A is prepared, and front and back faces of the silicon substrate 22 are thermally oxidized to form the insulating film 23 (thermal oxide film) made of Sio₂. As shown in FIG. 14B, the insulating film 23 is patterned on the surface of the silicon substrate 22 to leave the insulating film 23 only at the light-emitting-device-side end section of the silicon substrate 23. Further, a recess section 54 having a width same as that of the step portion 53 is formed on the insulating film 23.

Then, the silicon substrate 22 is dry-etched with the insulating film 23 as a mask. According to this process, the region of the upper face of the silicon substrate 23 exposed from the insulating film 23 is removed or dug by about 10 to about 20 μm to form the step portion 53 and a lower-step portion 55 shown in FIG. 14C. Further, as shown in FIG. 15A, the optical fiber holding section 40 having a form of V-shaped groove is formed by an anisotropic etching at the end section of the lower-step portion 55 opposite to the end section thereof where the insulating film 23 is provided. Thereafter, the lower-step portion 55 and the optical fiber holding section 40 are thermally oxidized to form the insulating film 23 on the whole front face and the whole back face of the silicon substrate 22 as shown in FIG. 15B. Note that the insulating film 23 on the back face of the silicon substrate 22 may be removed (not shown).

Then, as shown in FIG. 15C, the electrode pad 42 is provided at the predetermined position on the upper face of the silicon substrate 22 via the insulating film 23. The brazing filler metal 43 such as AuSn or the like is applied on the electrode pad 42. With this state, the electrode pad 42 is insulated from the silicon substrate 22 by the insulating film 23.

Subsequently, as shown in FIG. 16A, the optical waveguide 24 having the core 52 embedded between the upper and lower clads 27 and 28 is precisely positioned and formed on all over the upper surface of the silicon substrate 22. The optical waveguide 24 fabricated beforehand with another process may be overlapped on the upper surface of the silicon substrate 22 and fixedly bonded by an adhesive. In this case, a step portion is also provided at the bottom face of the optical waveguide 24 so as to match to the surface shape of the silicon substrate 22. Alternatively, the lower clad 28, core 52 and upper clad 27 may be successively formed on the silicon substrate 22 with the use of a semiconductor fabricating technique. At this process, the insulating film 23 is removed from the region where the optical waveguide is to be finally mounted, so that the optical waveguide 24 may be directly bonded to the silicon substrate 22.

Then, as shown in FIG. 16B, the optical waveguide 24 and the silicon substrate 22 are cut by a dicing blade or laser beam at the position of the end section of the lower-step portion 55 with the step portion 53 in the recess section 54 left, thereby forming the cut groove 39. Simultaneously, they are cut by the dicing blade or laser beam at the position passing the end section of the optical fiber holding section 40, thereby forming the cut groove 38. With this process, the end face of the optical waveguide 24 is formed and the groove composed of the cut groove 39 and the step portion 53 is formed.

The unnecessary sections of the optical waveguide 24 are separated, leaving the section between the cut grooves 38 and 39. In this case, the end face and side face of the optical waveguide 24 are smoothed so as to be unsusceptible to the optical coupling loss.

In order to separate the unnecessary sections of the optical waveguide 24 from the silicon substrate 22, the adhesive may be removed by an etching. Alternatively, the optical waveguide 24 is bonded to the silicon substrate 22 by using an ultraviolet curing type adhesive. In this case, the adhesive is not irradiated by ultraviolet ray at the unnecessary sections, so that the adhesive is not hardened at the unnecessary sections. Thus, the unnecessary sections of the optical waveguide 24 can easily be removed by merely using a cleaning process.

The light-emitting device 25 is placed on the electrode pad 41 that is exposed from the optical waveguide 24 as described above. Then, the light-emitting device 25 is pressurized to reflow the brazing filler metal 43. As shown in FIG. 16C, the light-emitting device 25 is bonded to the electrode pad 42 by the reflown brazing filler metal 43. Thus, the optical transmitter 51 is completed.

At this time, the step portion 53 is formed at the edge of the cut groove 39 and the surface of the step portion 53 is covered by the insulating film 23 on the side of the light-emitting device 25. Therefore, the brazing filler metal 43 is held at the space between the bottom face of the light-emitting device 25 and the step portion 53 covered with the insulating film 23 due to surface tension forces, even if the light-emitting device 25 is arranged close to the end face of the optical waveguide 24. Accordingly, it is difficult to drip the brazing filler metal 43 into the cut groove 39. Consequently, it is difficult to generate electrical crosstalk caused by the contact of the dripped brazing filler metal 43 to the silicon substrate 22, and further, it is difficult to generate electrical crosstalk with the other optical receiver or the like.

When the light-emitting device 25 is mounted, the light-emitting device 25 is positioned with a positioning mark formed on the silicon substrate 22 (silicon wafer) as a reference. The positioning mark used for mounting the light-emitting device 25 is desirably formed on the silicon substrate 22 with a mask same as that used for forming a positioning mark for bonding the optical waveguide 24. Using the same mask makes it possible to decrease the positional deviation between the optical waveguide 24 and the light-emitting device 25. Further, using the same mask upon forming the optical fiber holding section 40 enhances the positional precision between the optical waveguide 24 and the optical fiber. Moreover, as the method for mounting the light-emitting device 25, the outer pattern of the optical waveguide 24 may be actually recognized and the positioning may be performed on the basis of the end face and side face formed on the silicon substrate 22 by the cutting.

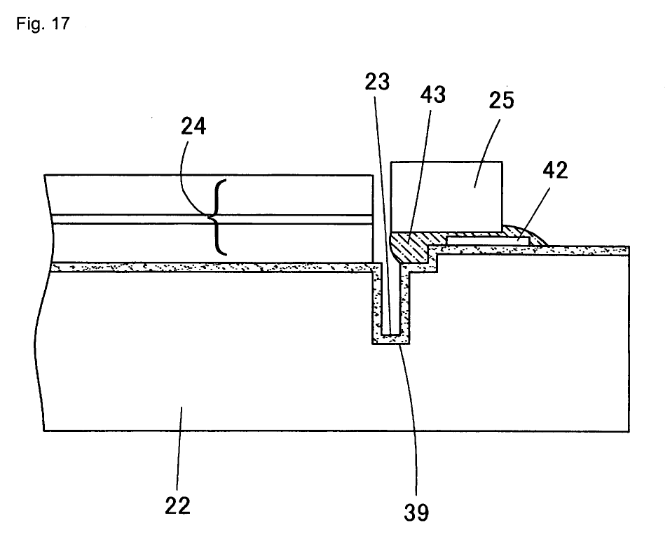

FIG. 17 shows an enlarged partial sectional view showing a modified example of the third embodiment of the present invention. In this modified example, the insulating film 23 is formed over the entire inside of the cut groove 39, and the entire silicon substrate 22 is covered with the insulating film 23. In order to cover the entire inside of the cut groove 39 with the insulating film 23, the insulating film 23 is formed at the inside of the cut groove 39 by a thermal oxidation after the cut groove 39 is formed by the dicing blade or laser beam. According to this modified example, the entire cut groove 39 is covered with the insulating film 23, whereby electrical crosstalk or electrical signal leakage is more surely prevented.

It should be noted that the step portion in the third embodiment may be provided to the optical transceiver according to the first embodiment. Further, the slope shown in the first embodiment may be provided to the optical transmitter in the third embodiment.

### EMBODIMENT 4

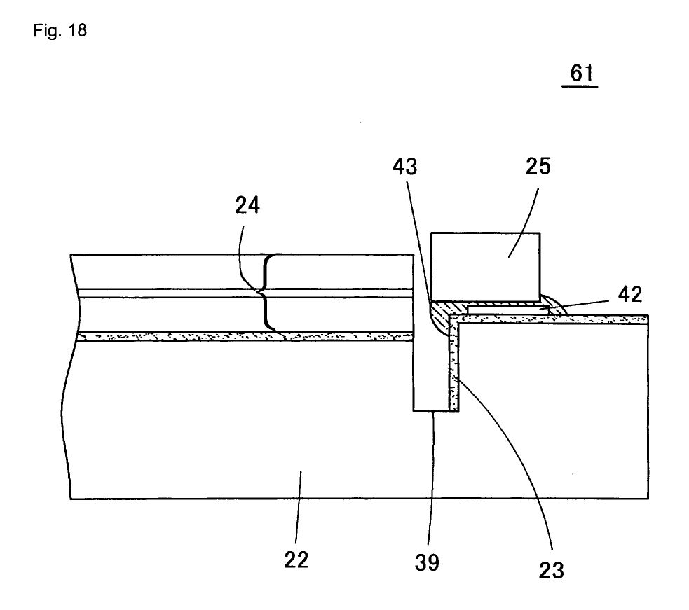

FIG. 18 shows an enlarged partial sectional view showing an optical waveguide module 61 according to an embodiment of the present invention. In this embodiment, the side wall face of the cut groove 39 positioned at the side of the electrode pad 42 is covered with the insulating film 23. The region of the side wall face covered with the insulating film 23 may be over the entire length (whole width of the silicon substrate 22) of the cut groove 39. Further, this region may only be the neighborhood of the mounting position of the light-emitting device 25. In this embodiment, even if the brazing filler metal 43 used for bonding the light-emitting device 25 onto the electrode pad 42 is dripped into the cut groove 39, there is no danger of generating an electrical leak or electrical crosstalk, so long as the dripped brazing filler metal does not reach the bottom face of the cut groove 39.

In order to fabricate the aforesaid optical waveguide module 61, the optical waveguide 24 and the silicon substrate 22 are cut to form the cut groove 39 on the silicon substrate 22. Simultaneously, the unnecessary sections of the optical waveguide 24 are separated. Thereafter, an insulating material such as SiO₂ or SiN is obliquely deposited by a sputtering or the like, thereby forming the insulating film 23 at the side face of the cut groove 39.

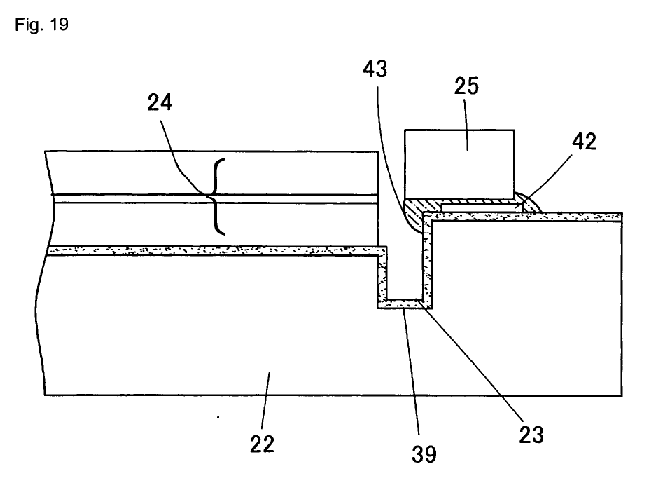

FIG. 19 shows an enlarged partial sectional view showing a modified example of an embodiment of the present invention. In this modified example, the cut groove 39 is formed, and then, an insulating material is formed in the cut groove 39 by a deposition or the like, thereby forming the insulating film 23 all over the inner face of the cut groove 39. Therefore, there is no danger of causing conduction between the light-emitting device 25 and the silicon substrate 22, even if the brazing filler metal 43 is dripped, with the result that an electrical leak or electrical crosstalk can more surely be prevented.

### EMBODIMENT 5

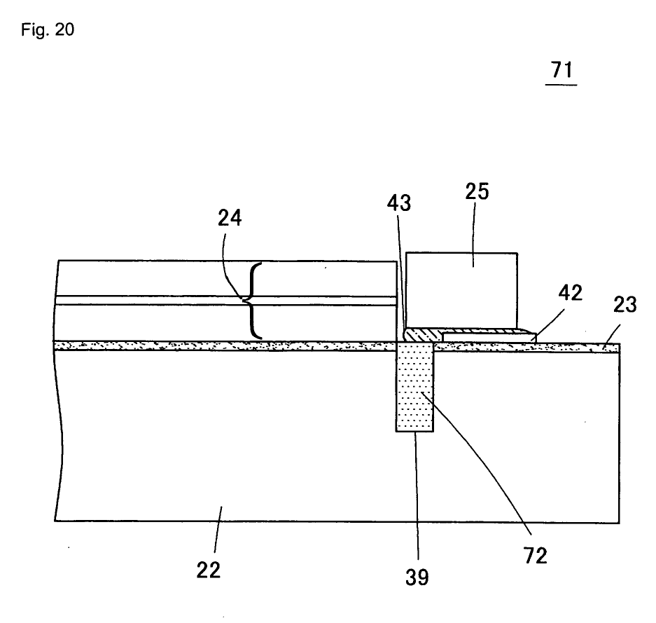

FIG. 20 shows an enlarged partial sectional view showing an optical waveguide module 71 according to an embodiment of the present invention. In this embodiment, the cut groove 39 is cut into the optical waveguide 24 and the silicon substrate 22 to separate the unnecessary sections of the optical waveguide 24. Thereafter, an insulating material 72 is filled in the cut groove 39 to fill the cut groove 39 with the insulating material 72. Accordingly, even if the brazing filler metal 43 used for bonding the light-emitting device 25 to the electrode pad 42 sticks out toward the cut groove 39, there is no danger of the brazing filler metal 43 entering the cut groove 39, and hence, there is no fear of the occurrence of the electrical leak or electrical crosstalk. Although not shown, an insulating film 23 may be additionally positioned within the cut groove 39 in a manner similar to that shown in FIG. 19.

### EMBODIMENT 6

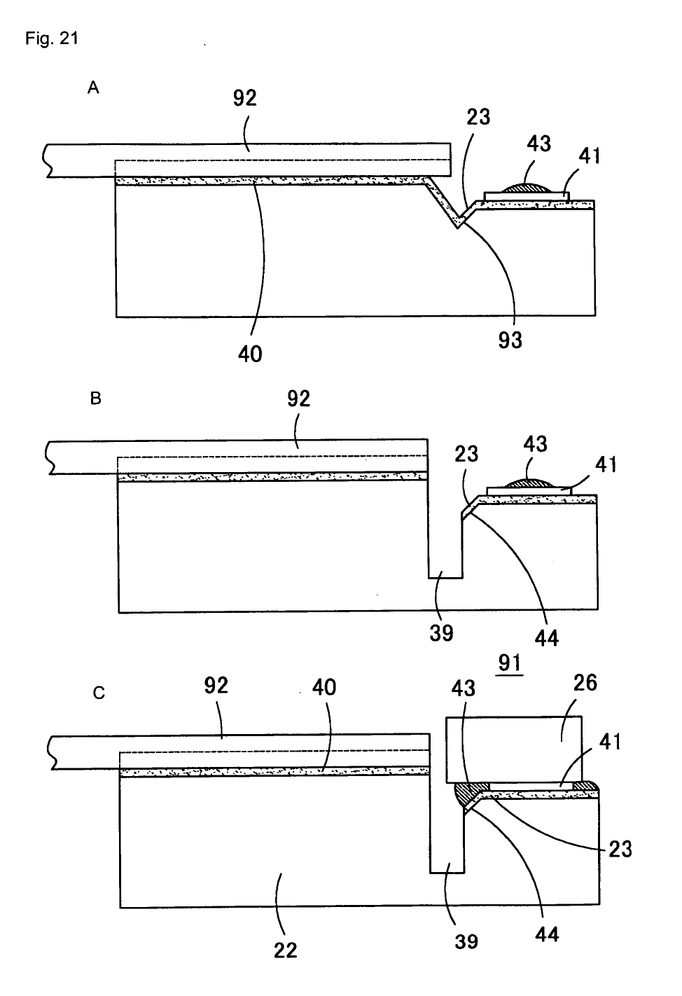

FIGS. 21A, B and C show schematic sectional views for explaining a manufacturing process of an optical receiver (optical fiber module) according to an embodiment of the present invention. In this embodiment, an optical fiber holding section 40 and V-shaped groove 93 are formed on the top face of the silicon substrate 22, and then, the entire top face of the silicon substrate 22 is thermally oxidized to form an insulating film 23, as shown in FIG. 21A. Further, an electrode pad 41 is provided via the insulating film 23 on the top face of the silicon substrate 22 in the vicinity of the V-shaped groove 93. Then, a brazing filler metal 43 of the electrode pad 41 is fixedly adhered. Subsequently, an optical fiber 92 is arranged in the optical fiber holding section 40, whereupon the optical fiber 92 is positioned and fixed to the optical fiber holding section 40 with an adhesive.

Thereafter, as shown in FIG. 21B, a groove is formed by cutting from the end section of the optical fiber 92 to the edge of the V-shaped groove 93 of the silicon substrate 22 with the use of a dicing blade or laser beam. With this process, the end face of the optical fiber 92 is finished to be smooth. At this time, a cut groove 39 is formed on the silicon substrate 22 so as to pass the end face of the optical fiber 92. Further, a slope 44 covered with the insulating film 23 is formed at the edge of the cut groove 39 by the remaining V-shaped groove 93.

Then, a light-receiving device 26 is placed on the electrode pad 41 and arranged so as to be proximate to the end face of the optical fiber 92. Next, the brazing filler metal 43 is reflown to bond the light-receiving device 26 to the electrode pad 41. Thus, the optical receiver 91 is completed. Even if the brazing filler metal 43 melted to be reflown sticks out toward the cut groove 39 from the bottom face of the light-receiving device 26 upon bonding the light-receiving device 26, the sticking brazing filler metal 43 is retained in a space between the lower face of the light-receiving device 26 and the slope 44. Therefore, the brazing filler metal 43 is prevented from entering the cut groove 39. As a result, this optical receiver 91 can reduce and/or eliminate the possibility of the occurrence of an electrical leak or electrical crosstalk caused by the undesirable migration of the brazing filler metal 43 into the cut groove 39.

It should be noted that, in the optical receiver according to the sixth embodiment, various forms described in the first to fifth embodiments and their modified examples can be applied to the shape of the neighborhood of the cut groove 39 or the region on which the insulating film 23 is provided.

Moreover, in each of the aforesaid embodiments, the light-emitting device 25 or the light-receiving device 26 is mounted so as to protrude toward the upper side of the cut groove 39. However, in any one of the embodiments and modified examples, the light-emitting device 25 or the light-receiving device 26 may be mounted so as to be recessed from the cut groove 39 as shown in FIG. 8.

Although the invention is shown and described with respect to certain illustrated aspects, it is to be appreciated that equivalent alterations and modifications will occur to others skilled in the art upon the reading and understanding of this specification and the annexed drawings. In particular regard to the various functions performed by the above described components, the terms used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention.

What is claimed is:

1. An optical module comprising:
a non-insulating substrate comprising a groove thereby forming a first region and a second region of the non-insulating substrate;
at least one of an optical waveguide and an optical fiber provided over the first region;
a first insulating film formed over at least a portion of the second region;
a second insulating film formed within at least a portion of the groove;
an electrode provided on the first insulating film; and
an optical component bonded to the electrode and positioned in a vicinity of the groove.

2. The optical module of claim 1, wherein the optical component is optically coupled to at least one of the optical waveguide and the optical fiber.

3. The optical module of claim 1, wherein the groove is positioned between at least one of the optical waveguide and the optical fiber and the electrode.

4. The optical module of claim 1, wherein an end face of at least one of the optical waveguide and the optical fiber is positioned coplanar with a side face of the groove.

5. The optical module of claim 1, wherein the first insulating film is adjacent the second insulting film thereby forming a unified insulating film.

6. The optical module of claim 1, wherein the second insulating film is formed over a side face of the groove.

7. The optical module of claim 1, wherein the groove comprises a step portion at the second region side, the second insulating film being formed over a surface of the step portion.

8. The optical module of claim 7, wherein the step portion is a slope.

9. The optical module of claim 1, wherein the optical component protrudes over at least a portion of the groove.

10. An optical module comprising:
a non-insulating substrate comprising a groove thereby forming a first region and a second region of the non-insulating substrate;
at least one of an optical waveguide and an optical fiber provided over the first region;
an insulating film formed over at least a portion of the second region;
an insulating material filled in at least a portion of the groove;
an electrode provided on the insulating film; and
an optical component bonded to the electrode and positioned in a vicinity of the groove.

11. The optical module of claim 10, wherein the upper surface of the insulating material in the groove is co-planar with an upper surface of the insulating film on the second region.

12. The optical module of claim 10, wherein the optical component protrudes over at least a portion of the groove.

13. A method of manufacturing an optical module, comprising:
forming a first insulating film on at least a second region of a non-insulating substrate, the non-insulating substrate comprising a first region and the second region;
forming a V-shaped groove in the non-insulating substrate between the first region and the second region;
forming a second insulating film in the V-shaped groove;
providing an electrode on the first insulating film in the second region;
providing at least one of an optical waveguide and an optical fiber on the first region;
forming a groove in the V-shaped groove, the groove in the non-insulating substrate being deeper than the V-shaped groove; and
bonding an optical component to the electrode after forming the groove.

14. The method of claim 13, further comprising forming a third insulating film within at least a portion of the groove.

15. The method of claim 13, further comprising cutting an end section of at least one of the optical waveguide and optical fiber while forming the groove in the V-shaped groove.

16. A method of manufacturing an optical module, comprising:
forming a first insulating film on at least a portion of a second region and at least a portion of a middle region of a non-insulating substrate, the non-insulating substrate comprising a first region, the middle region, and the second region;
removing at least a portion of the first region and at least a portion of the middle region of the non-insulating substrate;
forming a second insulating film on at least a portion of the removed portion of the middle region;
providing an electrode on the first insulating film;
providing at least one of an optical waveguide and an optical fiber on the first region;
forming a groove in at least a portion of the middle region; and
bonding a optical component to the electrode after forming the groove.

17. The method of claim 16, further comprising cutting an end section of at least one of the optical waveguide and optical fiber while forming the groove.

18. A method of manufacturing an optical module, comprising:
forming a first insulating film on at least a second region of a non-insulating substrate, the non-insulating substrate comprising a first region and the second region;
providing an electrode on the first insulating film in the second region;
providing at least one of an optical waveguide and an optical fiber on the first region;
forming a groove between the first region and the second region;
forming a second insulating film within at least a portion of the groove; and
bonding an optical component to the electrode after forming the groove.

19. The method of claim 18, further comprising filling at least a portion of the groove with an insulating material.

20. The method of claim 18, wherein the groove comprises a step region, and the second insulating film is formed over the step region.
